(19) United States
(12) Patent Application Publication
(10) Pub. No.: US 2012/0169157 A1
(43) Pub. Date: Jul. 5, 2012

(54) COOLING MODULE AND WATER-COOLED MOTOR SYSTEM USING THE SAME

(76) Inventors: Kou-Tzeng LIN, Zhudong Township (TW); Shin-Hung Chang, Zhongli City (TW); Tseng-Teh Wei, Hsinchu City (TW); Li-Ju Cheng, Hsinchu City (TW)

(21) Appl. No.: 13/287,700

(22) Filed: Nov. 2, 2011

(30) Foreign Application Priority Data
Dec. 31, 2010 (TW) 99147340

(51) Int. Cl. H02K 9/19; F28F 27/02; F28D 7/00

(52) U.S. Cl. 310/54; 165/164; 165/96

(57) ABSTRACT

A cooling module and a water-cooled motor system using the same are provided. The cooling module comprises a main body and a first flow passage assembly. The main body comprises a first lateral portion and a second lateral portion opposite the first lateral portion. The first flow passage assembly, disposed in the main body, comprises a first flow passage and a second flow passage. The first flow passage has a first end and a second end, wherein the first end is adjacent to the first lateral portion, and the second end is adjacent to the second lateral portion. The second flow passage has a third end and a fourth end, wherein the third end is connected to the second end of the first flow passage, and the fourth end is adjacent to the first lateral portion.

This application claims the benefit of Taiwan application Serial No. 99147340, filed Dec. 31, 2010, the subject matter of which is incorporated herein by reference.

### BACKGROUND

1. Technical Field

One embodiment relates in general to a cooling module and a water-cooled motor system using the same, and more particularly to a cooling module with flow passage and a water-cooled motor system using the same.

2. Description of the Related Art

The motor has a wide range of application. Let the electric vehicle be taken for example. The electric vehicle transmits the electric power generated by the battery to the motor for rotating the motor. Through the transmission system, the kinetic energy is transmitted to the wheels for moving the vehicle. In recent years, as the electric vehicle demands higher kinetic energy, the input current of the motor coil increases and the generated heat also increases accordingly. If the generated heat is not carried away promptly, high temperature will cause damage to motor elements.

Referring to FIG. 1, a conventional cooling device according to prior art is shown. The motor comprises a cooling device 10 and a motor assembly (not illustrated). The cooling device 10 is connected to a motor assembly for dissipating the heat generated by the motor assembly to the exterior. The cooling device 10 comprises a casing 12 and a cooling flow passage 14. The casing 12 has a first end surface 16 and a second end surface 18 opposite to the first end surface 16. The cooling flow passage 14 is located inside the casing 12, and surrounds the casing 12 along a circumference direction of the axial line AX1 of the casing 12 for a circle. The width W is slightly smaller than the distance between the first end surface 16 and the second end surface 18, and a cooling fluid, when passing through the cooling flow passage 14, carries away the heat generated by the motor.

In comparison to the middle portion of cooling flow passage 14, the exterior portions of the cooling flow passage 14 that are adjacent to the first end surface 16 and the second end surface 18 exist a stronger resistance. When the cooling fluid surrounds the casing 12 for a circle along the cooling flow passage 14, the cooling fluid flows slower in the parts of the cooling flow passage 14 that are adjacent to the first end surface 16 and the second end surface 18 or even forms stagnation in these parts, and the cooling effect in these parts is thus deteriorated.

### SUMMARY

One embodiment is a cooling module and a water-cooled motor system using the same. The cooling fluid inside the cooling module passes through the parts of the cooling module that are adjacent to the first lateral portion and the second lateral portion so as to carry the heat away from the parts of the cooling module that are adjacent to the first lateral portion and the second lateral portion and increase the cooling efficiency of the cooling module.

A cooling module applicable to a water-cooled motor system is provided. The cooling module comprises a main body and a first flow passage assembly. The main body comprises a first lateral portion and a second lateral portion opposite to the first lateral portion. The first flow passage assembly, disposed in the main body, comprises a first flow passage and a second flow passage. The first flow passage has a first end and a second end, wherein the first end is adjacent to one of the first lateral portion and the second lateral portion, and the second end is adjacent to the other one of the first lateral portion and the second lateral portion. The second flow passage has a third end and a fourth end, wherein the third end is connected to the second end of the first flow passage, and the fourth end is adjacent to one of the first lateral portion and the second lateral portion.

A water-cooled motor system is provided. The water-cooled motor system comprises a cooling module and a motor assembly. The cooling module comprises a main body and a first flow passage assembly. The main body comprises a first lateral portion and a second lateral portion opposite to the first lateral portion. The first flow passage assembly, disposed in the main body, comprises a first flow passage and a second flow passage. The first flow passage has a first end and a second end, wherein the first end is adjacent to one of the first lateral portion and the second lateral portion, and the second end is adjacent to the other one of the first lateral portion and the second lateral portion. The second flow passage has a third end and a fourth end, wherein the third end is connected to the second end of the first flow passage, and the fourth end is adjacent to one of the first lateral portion and the second lateral portion. A motor assembly is disposed in the main body to deliver a traction power.

The disclosure will become better understood with regard to the following detailed description of the non-limiting embodiment(s). The following description is made with reference to the accompanying drawings.

### BRIEF DESCRIPTION OF THE DRAWINGS

FIG. 1 shows a conventional cooling device;

FIG. 2 shows a 3-D diagram of a water-cooled motor system according to an embodiment of the disclosure;

FIG. 3 shows a 3-D diagram of a middle housing of a main body of FIG. 2;

FIG. 4 shows a 3-D diagram of a flow passage according to an embodiment of the disclosure;

FIG. 5 shows an expansion diagram of a flow passage of FIG. 4;

FIG. 6 shows a flow passage according to an implementation of the disclosure;

FIG. 7 shows a fluid flow control method according to an implementation of the disclosure;

FIG. 8 shows a fluid flow control method according to another implementation of the disclosure;

FIG. 9 shows a cross-sectional view of a main body of a cooling module according to an implementation;

FIG. 10 shows an expansion diagram of a flow passage according to an implementation of the disclosure;

FIG. 11 shows an expansion diagram of a flow passage according to another implementation of the disclosure;

FIG. 12 shows an expansion diagram of a flow passage according to further implementation of the disclosure;

FIG. 13 shows an expansion diagram of a flow passage according to yet another implementation of the disclosure.

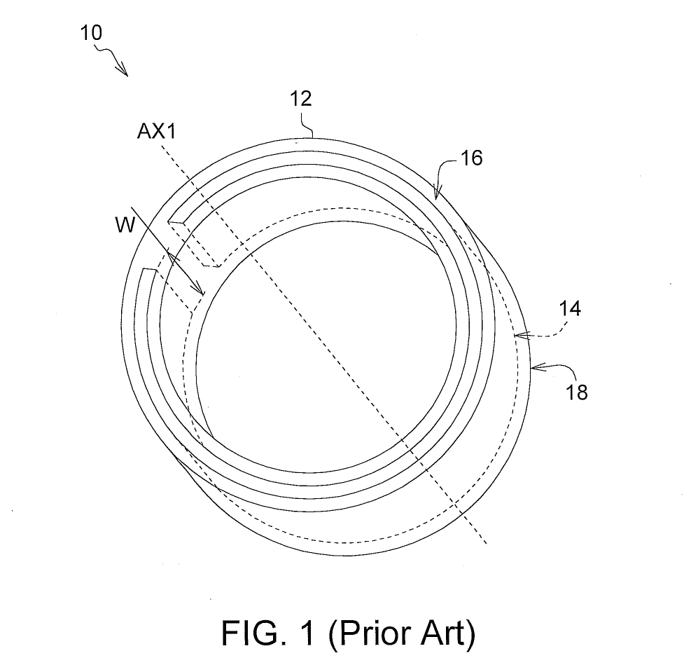

### DETAILED DESCRIPTION

In the following elaboration, the phrase “connected to” not only refers to direct connection but also refers to indirect connection. That is, two elements can be directly connected or can be indirectly connected through at least another element. The phrase “adjacent to” refers to two elements being close to each other either with or without direct contact.

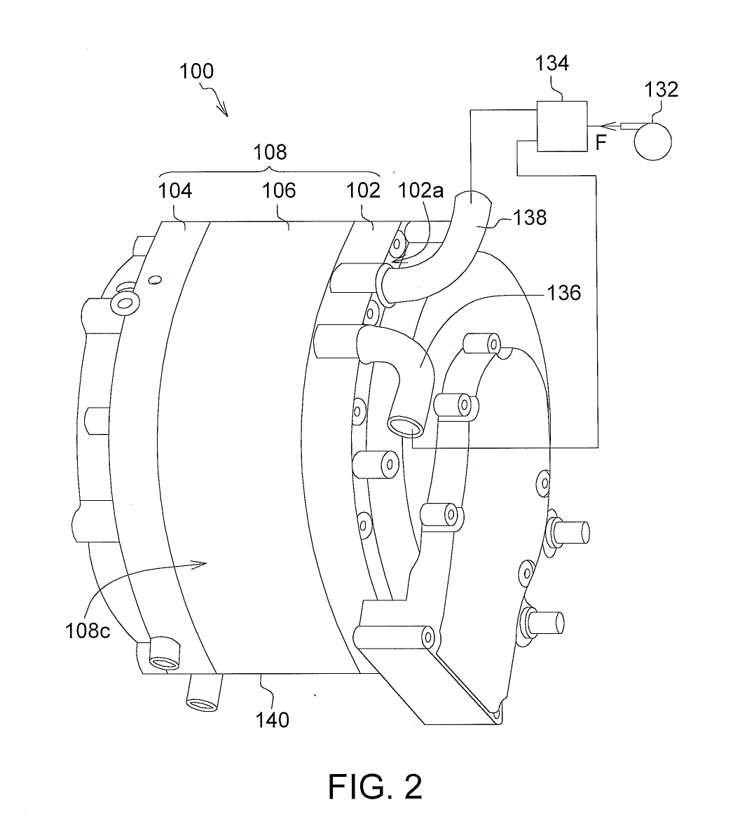

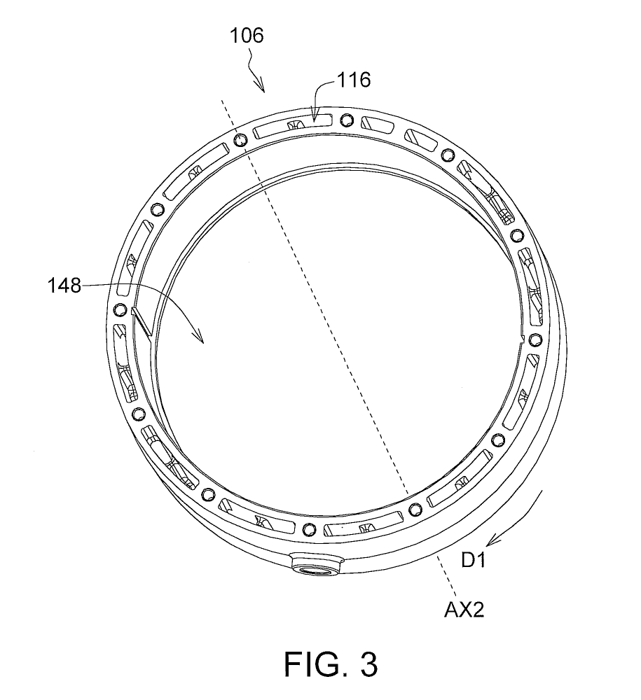

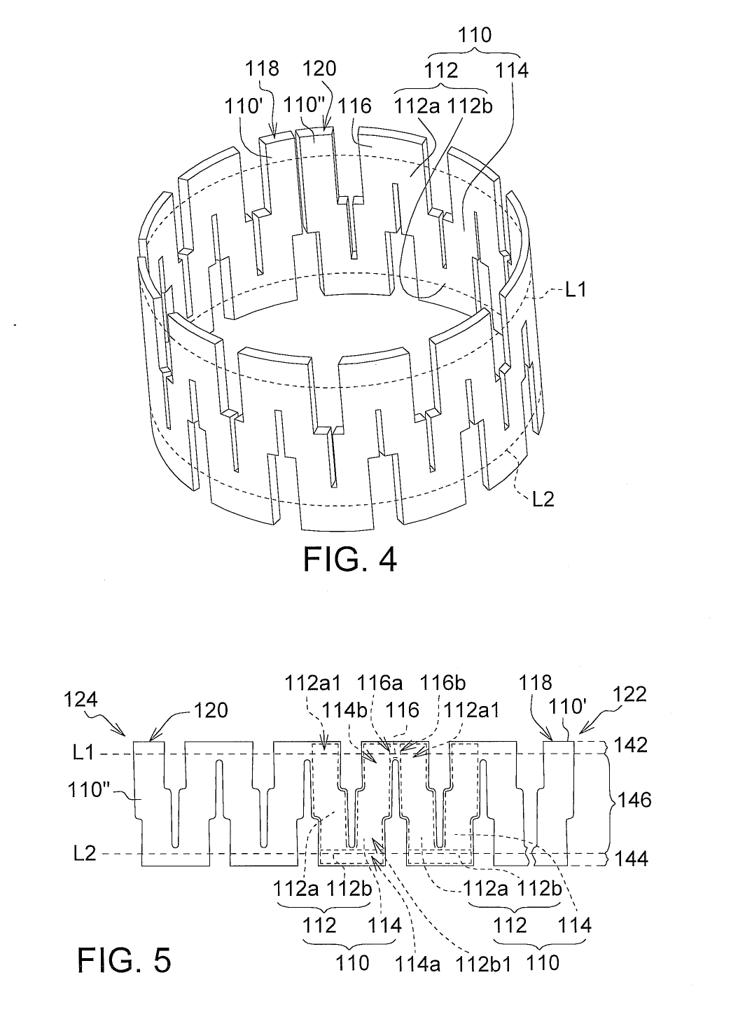

Referring to FIG. 2, FIG. 3 and FIG. 4. FIG. 2 shows a 3-D diagram of a water-cooled motor system according to an embodiment of the disclosure. FIG. 3 shows a 3-D diagram of a middle housing of a main body of FIG. 2. FIG. 4 shows a 3-D diagram of a flow passage according to an embodiment of the disclosure. As indicated in FIG. 2, the water-cooled motor system 100 comprises a cooling module 140 and a motor assembly (not illustrated).

Referring to FIG. 2, the motor assembly, located inside the cooling module 140, at least comprises a rotor (not illustrated), a stator (not illustrated), and a coil (not illustrated) for delivering traction power. The motor assembly generates heat during the process of operation. The cooling module 140 can dissipate the heat generated by the motor assembly to the cooling water promptly.

Referring to FIGS. 2 to 4, the cooling module 140 comprises a main body 108, a plurality of first flow passage assemblies 110 (illustrated in FIG. 4), a third flow passage 116 (illustrated in FIG. 4), a first opening 118 (illustrated in FIG. 4) and a second opening 120 (illustrated in FIG. 4). The main body 108 comprises a first lateral portion 102, a second lateral portion 104, and a middle housing 106. The first lateral portion 102 is such as a right housing, and the second lateral portion 104 is such as a left housing. In another embodiment, the first lateral portion 102 and the second lateral portion 104 can respectively be two opposite lateral surfaces or end surfaces of the middle housing 106. The main body has a ring wall for defining an accommodation space, and the abovementioned rotor, fixer and coil can be located in the accommodation space. One embodiment, the middle housing 106 of the main body 108 is a ring wall, which surrounds an axial line AX2 for a cycle for defining an accommodation space 148 in which the abovementioned rotor, fixer and coil are located.

Referring to FIG. 4, adjacent two first flow passage assemblies 110 are connected through the third flow passage 116. The quantity of the first flow passage assemblies 110 and that of the third flow passage 116 are not limited, and no particular restrictions are imposed in the embodiments of the disclosure.

The first flow passage assemblies 110 are extended back and forth between the first lateral portion 102 (illustrated in FIG. 2) and the second lateral portion 104 (illustrated in FIG. 2) of the main body 108 and simultaneously extended along a surrounding direction D1 (illustrated in FIG. 3) which surrounds the axial line AX2. As indicated in FIG. 4, the first flow passage assemblies 110 are extended to be adjacent to one of the first lateral portion 102 and the second lateral portion 104 and then return to be the other one of the first lateral portion 102 and the second lateral portion 104. Thus, the cooling fluid, when flowing through one single first flow passage assembly 110, carries the heat away from the parts of the first flow passage assembly 110 that are adjacent to the first lateral portion 102 and the second lateral portion 104 so as to increase the cooling efficiency of the cooling module 140. In addition, as the first flow passage assemblies 110 are extended back and forth between the first lateral portion 102 and the second lateral portion 104, the first flow passage assemblies 110 can be extended along a surrounding direction D1 of the main body 108 for a cycle, a half cycle or any length. In the present embodiment of the disclosure, the first flow passage assemblies 110 are extended along a surrounding direction D1 of the main body 108 for a cycle.

Referring to FIG. 5, an expansion diagram of a flow passage of FIG. 4 is shown. The first flow passage assemblies 110 and the third flow passage 116 can be located in at least one of the first lateral portion 102 (the right housing) (not illustrated in FIG. 5), the second lateral portion 104 (the left housing) (not illustrated in FIG. 5) and the middle housing 106. (not illustrated in FIG. 5) One embodiment, the first flow passage assemblies 110 can be located in the first lateral portion 102, the second lateral portion 104 and the middle housing 106 at the same time. In detail, the upper portion 142 of the first flow passage assemblies 110′ (that is, the portion above the first border line L1) and at least one portion of the third flow passage 116 can be located in the first lateral portion 102. The lower portion 144 of the first flow passage assemblies 110 (that is, the portion below the second border line L2) can be located in the second lateral portion 104. The middle portion 146 of the first flow passage assemblies 110 (that is, the portion between the first border line L1 and the second border line L2) and the remaining portion of the third flow passage 116 can be located in the middle housing 106. In an embodiment, if the middle housing 106 does not comprise any flow passages, the middle housing 106 can be omitted in the main body 108. In addition, if the first lateral portion 102 does not comprise any flow passages, the first lateral portion 102 can be omitted in the main body 108. If the second lateral portion 104 does not comprise any flow passages, the second lateral portion 104 can be omitted in the main body 108.

Referring to FIG. 5, two adjacent first flow passage assemblies 110 are connected through a third flow passage 116, so that the first flow passage assemblies 110 and the third flow passages 116 together form a chain structure.

The extension path of the first flow passage assemblies is like an inverted U. One embodiment, each first flow passage assembly 110 comprises a first flow passage 112 and a second flow passage 114. The first flow passage 112 comprises a first sub-flow passage 112a and a second sub-flow passage 112b, and has a first end 112a1 and a second end 112b1, wherein the first end 112a1 is one end of the first sub-flow passage 112a, and the second end 112b1 is one end of the second sub-flow passage 112b. The extension direction of the first sub-flow passage 112a is substantially parallel to that of the second flow passage 114, and the extension direction of the second sub-flow passage 112b is substantially perpendicular to that of the first sub-flow passage 112a, so that the first flow passage 112 and the second flow passage 114 together form a U-shaped flow passage.

The first end 112a1 of the first flow passage 112 is adjacent to one of the first lateral portion 102 and the second lateral portion 104, and the second end 112b1 of the first flow passage 112 is adjacent to the other one of the first lateral portion 102 and the second lateral portion 104. The third end 114a of the second flow passage 114 is connected to the second end 112b1 of the first flow passage 112, and the fourth end 114b of the second flow passage 114 is adjacent to the one of the first lateral portion 102 and the second lateral portion 104. One embodiment, the first end 112a1 of the first sub-flow passage 112a of the first flow passage 112 is adjacent to the first lateral portion 102, the second end 112b1 of the second sub-flow passage 112b of the first flow passage 112 is adjacent to the second lateral portion 104, and the fourth end 114b of the second flow passage 114 is adjacent to the first lateral portion 102. The second flow passage 114 has a third end 114a and a fourth end 114b. The second sub-flow passage 112b is extended along a surrounding direction D1 of the main body 108 and is connected to the third end 114a of the second flow passage 114 by the second end 112b1 of the first flow passage 112. That is, the third end 114a of the second flow passage 114 is adjacent to the second lateral portion 104. In other implementations, the first end 112a1 of the first sub-flow passage 112a is adjacent to the second lateral portion 104, the second end 112b1 of the second sub-flow passage 112b is adjacent to the first lateral portion 102, and the fourth end 114b of the second flow passage 114 is adjacent to the second lateral portion 104.

The third flow passage 116 connects the fourth end 114b of the second flow passage 114 of a first flow passage assembly 110 adjacent to the third flow passage 116 to the first end 112a1 of the first sub-flow passage 112a of another first flow passage assembly 110 adjacent to the third flow passage 116. One embodiment, the third flow passage 116 has a fifth end 116a and a sixth end 116b opposite to the fifth end 116a, the fifth end 116a connects the fourth end 114b of the second flow passage 114 adjacent to the fifth end 116a, and the sixth end 116b connects the first end 112a1 of the first sub-flow passage 112a adjacent to the sixth end 116b. In the present embodiment of the disclosure, the third flow passage 116 connects the fourth end 114b of the second flow passage 114 to the first end 112a1 of the first sub-flow passage 112a along a surrounding direction D1 of the main body 108.

Two adjacent first flow passage assemblies are substantially symmetric to each other. Therefore, the pressure drops which occur to the cooling fluid every time when the cooling fluid flows back and forth between the first lateral portion 102 and the second lateral portion 104 are substantially the same. Let the first flow passage assemblies 110 be taken for example. As two adjacent first flow passage assemblies 110 are substantially symmetric with respect to the third flow passage 116, the pressure drops which occur to the cooling fluid every time when the cooling fluid flows back and forth between the first end 112a1 of each first flow passage 112 and the fourth end 114b of each second flow passage 114 are substantially the same. The combine effect of uniform pressure drop and the symmetric characteristics together make the cooling fluid with uniform flow rate and temperature distribution.

As indicated in FIG. 5, the first opening 118 is located at the first flow passage assembly 110′ of the first flow passage assemblies 110 that is located at one end 122 of the first flow passage assemblies 110 (that is, one end of the chain structure). The second opening 120 is located at the first flow passage assembly 110″ of the first flow passage assemblies 110 that is located at the other end 124 of the first flow passage assemblies 110 (that is, another end of the chain structure). One embodiment, the first opening 118 and the second opening 120 are exposed from the lateral surface 102a of the first lateral portion 102. As indicated in FIG. 2, the cooling module 140 further comprises a first tube 136 and a second tube 138, wherein the first tube 136 and the second tube 138 are respectively connected to the first opening 118 and the second opening 120, so that the cooling fluid F can enter the flow passage assemblies either through the first tube 136 or the second tube 138.

In other implementations, the first opening 118 and the second opening 120 can be exposed from the peripheral surface 108c (the peripheral surface 108c is illustrated in FIG. 2) of the main body 108, so that the first tube 136 and the second tube 138 can be respectively connected to the first opening 118 and the second opening 120 through the peripheral surface 108c of the main body 108. The peripheral surface 108c of the main body 108 can be the peripheral surface of one of the first lateral portion 102, the middle housing 106 and the second lateral portion 104.

The first opening 118 can be used as one of a water outlet and a water inlet, and the second opening 120 can be used as the other one of a water inlet and a water outlet. For example, the first opening 118 or the second opening 120 can be switched as a water inlet by a direction control valve. In detail, the cooling module 140 (as illustrated in FIG. 2) further comprises a direction control valve 134, which connects the first tube 136 (or the first opening 118) and the second tube 138 (or the second opening 120) of the first flow passage assemblies 110 and a pump 132. The direction control valve 134 may guide the cooling fluid F from the pump 132 to the first flow passage assemblies 110 through the first opening 118 or the second opening 120. In other implementations, the direction control valve 134 can be omitted in the cooling module 140, so that the cooling fluid F can enter the first flow passage assemblies 110 through one of the first opening 118 and the second opening 120 directly.

In the embodiments, the cooling module has only one set of water inlet and water outlet. However, in other implementations, the cooling module may comprise multiple sets of independent flow passage assemblies. At least one embodiment is disclosed below to elaborate the disclosure.

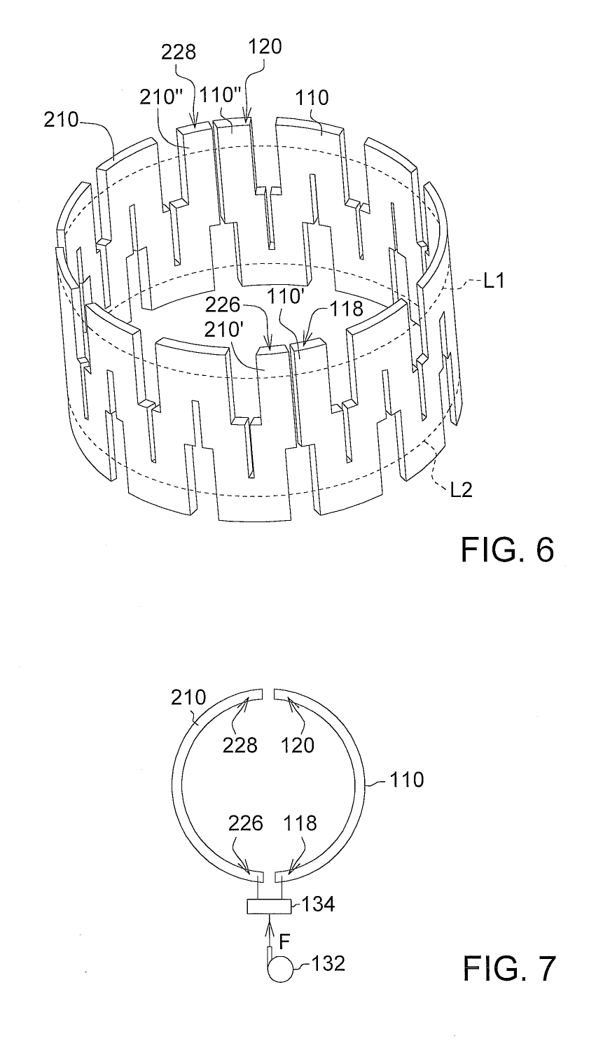

Referring to FIG. 6, a flow passage according to an implementation of the disclosure is shown. The cooling module of an implementation comprises a plurality of first flow passage assemblies 110, a plurality of second flow passage assemblies 210, a first opening 118, a second opening 120, a third opening 226, and a fourth opening 228. The second flow passage assemblies 210 and the first flow passage assemblies 110 are separated from each other. The first opening 118 can be used as one of a water outlet and a water inlet, and the second opening 120 can be used as the other one of a water inlet and a water outlet. Likewise, the third opening 226 can be used as one of a water outlet and a water inlet, and the fourth opening 228 can be used as the other one of a water inlet and a water outlet. The structures of the second flow passage assemblies 210 are similar to that of the first flow passage assemblies 110, and the similarities are not repeated here.

In addition, the first opening 118 is located at the first flow passage assembly 110′ of the first flow passage assemblies 110 that is located at one end, and the second opening 120 is located at the first flow passage assembly 110″ of the first flow passage assemblies 110 that is located at the other end. The third opening 226 is located at the second flow passage assemblies 210′ of the second flow passage assemblies 210 that is located at one end of the second flow passage assemblies 210, and the fourth opening 228 is located at the second flow passage assemblies 210″ of the second flow passage assemblies 210 that is located at the other end of the second flow passage assemblies 210. Wherein, the second opening 120 is adjacent to the fourth opening 228, and the first opening 118 is adjacent to the third opening 226.

In comparison to the implementation with one single flow passage assembly (such as the first flow passage assembly 110 of FIG. 4), the cooling fluid has lower outlet temperature in the implementation with multiple flow passage assemblies (such as the first flow passage assemblies 110 and the second flow passage assemblies 210 of FIG. 6) One embodiment, the fluid temperature difference between first opening 118 and second opening 120 of the two flow passage assemblies in FIG. 6 is smaller than the fluid temperature difference between two openings 118 and 120 of the single flow passage assembly in FIG. 4. Also, the fluid temperature difference between third opening 226 and fourth opening 228 of the two flow passage assemblies in FIG. 6 is smaller than the fluid temperature difference between two openings 118 and 120 of the single flow passage assembly in FIG. 4.

Referring to FIG. 7, a fluid flow control method according to an implementation of the disclosure is shown. The direction control valve 134 can connect the first flow passage assemblies 110, the second flow passage assemblies 210, and a pump 132 for transmitting the cooling fluid F from the pump 132 either to the first flow passage assemblies 110 or to the second flow passage assemblies 210. The direction control valve 134 connects the first opening 118, the third opening 226, and the pump 132 together. Such valve can guide the cooling fluid F from the pump to the first flow passage assemblies 110 through the first opening 118, the cooling fluid F can be guided to the second flow passage assemblies 210 through the third opening 226 also.

The direction control valve 134 of FIG. 7 can be realized by a three-way valve capable of guiding the cooling fluid F to enter both of the first flow passage assemblies 110 and the second flow passage assemblies 210 at the same time or only one of the first flow passage assemblies 110 and the second flow passage assemblies 210.

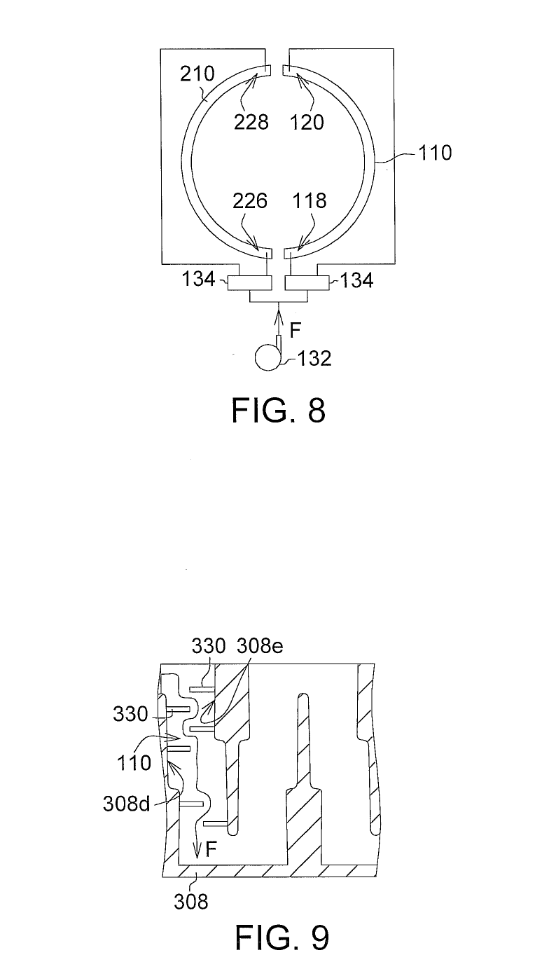

Referring to FIG. 8, a fluid flow control method according to another implementation of the disclosure is shown. The cooling module of another implementation comprises two direction control valves 134. One of the direction control valves 134 connects the first opening 118 and the second opening 120 of the first flow passage assemblies 110 and the pump 132 for transmitting the cooling fluid F from the pump 132 to the first flow passage assemblies 110. The other one of the direction control valves 134 connects the third opening 226 and the fourth opening 228 of the second flow passage assemblies 210 and the pump 132 for transmitting the cooling fluid F from the pump 132 to the second flow passage assemblies 210.

Referring to FIG. 9, a cross-sectional view of a main body of a cooling module according to an implementation is shown. The cooling fluid can be circulated in at least one of the first flow passage assemblies and the third flow passage. In detail, the main body 308 further comprises a plurality of dividers 330, and has a first inner lateral wall 308d and a second inner lateral wall 308e, wherein the first inner lateral wall 308d and the second inner lateral wall 308e are opposite to each other and corresponding to the first flow passage assembly 110. The dividers 330 are disposed on the first inner lateral wall 308d and the second inner lateral wall 308e for changing the flowing direction of the cooling fluid F flowing through the first flow passage assembly 110. In the present embodiment of the disclosure, two of the dividers 330 are respectively disposed on the first inner lateral wall 308d and the second inner lateral wall 308e and are separated by a distance along the extension direction of the first flow passage assemblies 110. With the disposition of the dividers 330, the path line of the cooling fluid F flowing through the first flow passage assemblies 110 is circuitous as indicated in FIG. 9.

Though the extension path of the first flow passage assemblies 110 is exemplified by an inverted U, the disclosure is not limited thereto. The extension path of the first flow passage assemblies 110 can also be saw-toothed. At least one embodiment is disclosed below to elaborate the disclosure.

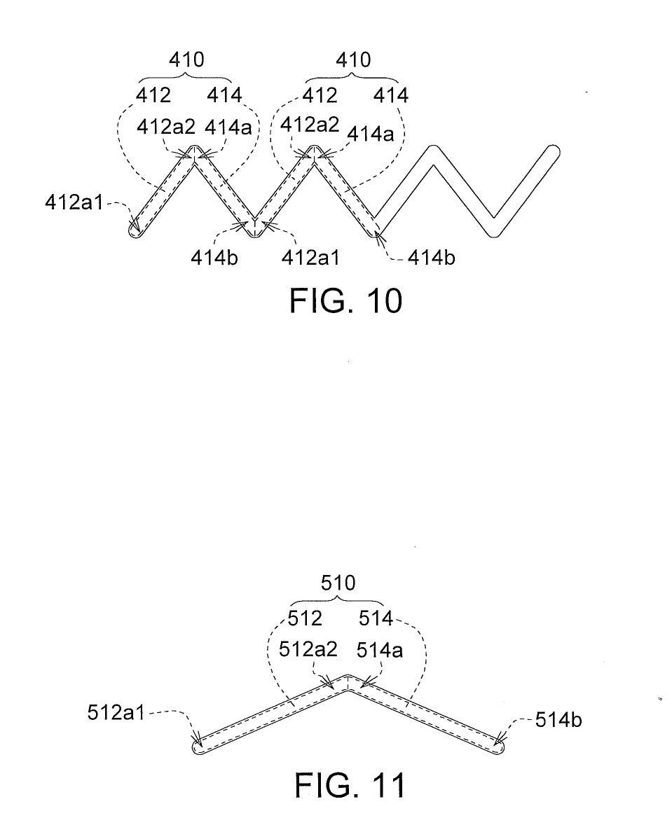

Referring to FIG. 10, an expansion diagram of a flow passage according to an implementation of the disclosure is shown. Each first flow passage assembly 410 is saw-toothed and comprises a first flow passage 412 and a second flow passage 414. The first flow passage 412 has a first end 412a1 and a second end 412a2 opposite to the first end 412a1. The first end 412a1 of the first flow passage 412 is adjacent to one of the first lateral portion 102 and the second lateral portion 104, and the second end 412a2 of the first flow passage 412 is adjacent to the other one of the first lateral portion 102 and the second lateral portion 104. The second flow passage 414 has a third end 414a and a fourth end 414b opposite to the third end 414a, wherein the third end 414a of the second flow passage 414 is connected to the second end 412a2 of the first flow passage 412, and the fourth end 414b of the second flow passage 414 is adjacent to the one of the first lateral portion 102 and the second lateral portion 104. That is, the fourth end 414b and the first end 412a1 of the first flow passage 412 are adjacent to the same end surface (that is, the first lateral portion 102 or the second lateral portion 104). Of the first flow passage assemblies 410, the fourth end 414b of the second flow passage 414 of a first flow passage assembly 410 is connected to the first end 412a1 of the first flow passage 412 of an adjacent first flow passage assembly 410 so that the first flow passage assemblies 410 together form a chain structure.

Though the cooling module of the above embodiment of the invention is exemplified by comprising several first flow passage assemblies, however, in another implementation, the cooling module may comprise only one single first flow passage assembly. The single first flow passage assembly is extended to be adjacent to one of the first lateral portion 102 and the second lateral portion 104, and then returns to be adjacent to the other one of the first lateral portion 102 and the second lateral portion 104. Meanwhile, the single first flow passage assembly is extended along a surrounding direction D1 of the main body 108 for a cycle. Thus, the cooling fluid, when flowing through single first flow passage assembly, flows back and forth between the first lateral portion 102 and the second lateral portion 104 to carry the heat away from the parts of the single first flow passage assembly that are adjacent to the first lateral portion 102 and the second lateral portion 104 so as to increase the cooling efficiency of the cooling module. Let the saw-toothed single first flow passage assembly be taken for example.

Referring to FIG. 11, an expansion diagram of a flow passage according to another implementation of the disclosure is shown. The cooling module comprises single first flow passage assembly 510. The single first flow passage assembly 510 comprises a first flow passage 512 and a second flow passage 514, wherein the first flow passage 512 has a first end 512a1 and a second end 512a2 opposite to the first end 512a1. The first end 512a1 of the first flow passage 512 is adjacent to one of the first lateral portion 102 and the second lateral portion 104, and the second end 512a2 of the first flow passage 512 is adjacent to the other one of the first lateral portion 102 and the second lateral portion 104. The second flow passage 514 has a third end 514a and a fourth end 514b opposite to the third end 514a. The third end 514a of the second flow passage 514 is connected to the second end 512a2 of the first flow passage 512, and the fourth end 514b of the second flow passage 514 is adjacent to the one of the first lateral portion 102 and the second lateral portion 104. That is, the fourth end 514b and the first end 512a1 of the first flow passage 512 are adjacent to the same end surface (that is, the first lateral portion 102 or the second lateral portion 104).

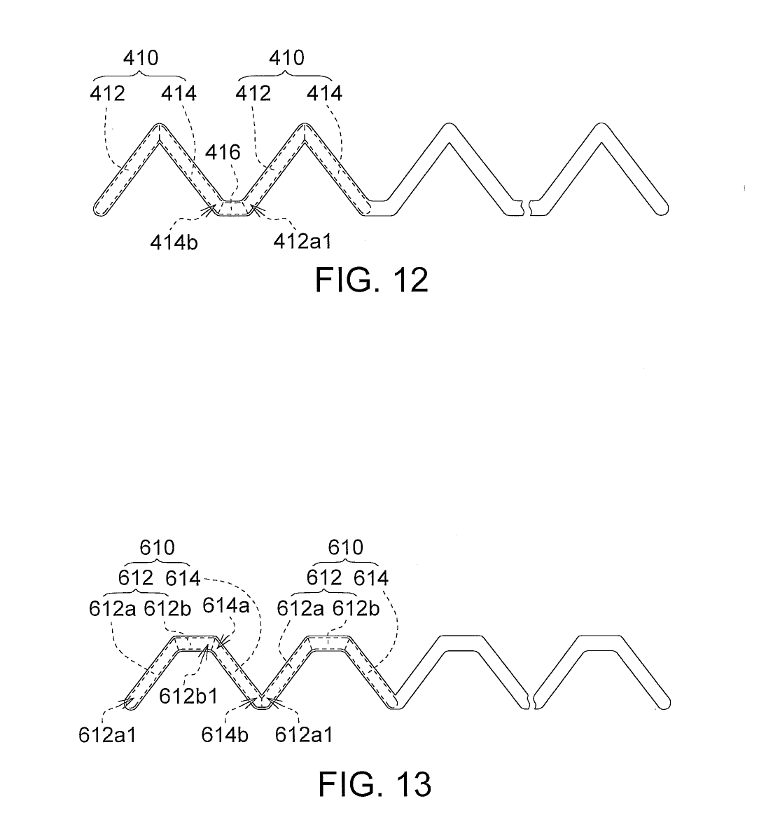

Referring to FIG. 12, an expansion diagram of a flow passage according to further an implementation of the disclosure is shown. The cooling module comprises a plurality of first flow passage assemblies 410 and a plurality of third flow passages 416. Each third flow passage 416 connects the fourth end 414b of the second flow passage 414 of a first flow passage assembly 410 adjacent to the third flow passage 416 to the first end 412a1 of the first flow passage 412 of another first flow passage assembly 410 adjacent to the third flow passage 416 along a surrounding direction D1 of the main body 108.

Referring to FIG. 13, an expansion diagram of a flow passage according to yet another implementation of the disclosure is shown. The cooling module comprises a plurality of first flow passage assemblies 610. Each first flow passage assembly 610 comprises a first flow passage 612 and a second flow passage 614. The first flow passage 612 comprises a first sub-flow passage 612a and a second sub-flow passage 612b, and has a first end 612a1 and a second end 612b1 opposite to the first end 612a1, wherein the first end 612a1 is one end of the first sub-flow passage 612a, the second end 612b1 is one end of the second sub-flow passage 612b, and the second flow passage 614 has a third end 614a and a fourth end 614b opposite to the third end 614a. The first end 612a1 of the first sub-flow passage 612a is adjacent to one of the first lateral portion 102 and the second lateral portion 104, the second end 612b1 of the second sub-flow passage 612b is adjacent to the other one of the first lateral portion 102 and the second lateral portion 104, and the fourth end 614b of the second flow passage 614 is adjacent to the one of the first lateral portion 102 and the second lateral portion 104. That is, the fourth end 614b and the first end 612a1 of the first flow passage 612 are adjacent to the same end surface (that is, the first lateral portion 102 or the second lateral portion 104). Of the first flow passage assemblies 610, the second sub-flow passage 612b is extended along a surrounding direction D1 of the main body 108 and is connected to the third end 614a of the second flow passage 614 by the second end 612b1, and the fourth end 614b of the second flow passage 614 of a first flow passage assembly 610 is connected to the first end 612a1 of the first flow passage 612 of an adjacent first flow passage assembly 610 so that the first flow passage assemblies 610 together form a chain structure.

According to the cooling module and the water-cooled motor system using the same disclosed in above embodiments of the disclosure, the cooling fluid inside the cooling module can carry the heat away from the portions of the cooling module that are adjacent to the first lateral portion and the second lateral portion so as to increase the cooling efficiency of the cooling module.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A cooling module applicable to a water-cooled motor system, wherein the cooling module comprises:
a main body comprising a first lateral portion and a second lateral portion opposite to the first lateral portion; and
a first flow passage assembly disposed in the main body, wherein the first flow passage assembly comprises:
a first flow passage having a first end and a second end, wherein the first end is adjacent to one of the first lateral portion and the second lateral portion, and the second end is adjacent to the other one of the first lateral portion and the second lateral portion; and
a second flow passage having a third end and a fourth end, wherein the third end is connected to the second end of the first flow passage, and the fourth end is adjacent to one of the first lateral portion and the second lateral portion.

2. The cooling module according to claim 1, further comprising:
a plurality of first flow passage assemblies, wherein the fourth end of the second flow passage of each first flow passage assembly is connected to the first end of the first flow passage of the adjacent first flow passage assembly.

3. The cooling module according to claim 2, further comprising:
a plurality of third flow passages, wherein each third flow passage connects the fourth end of the second flow passage of the adjacent first flow passage assembly and the first end of the first flow passage of the adjacent first flow passage assembly.

4. The cooling module according to claim 1, wherein the first flow passage comprises:
a first sub-flow passage having the first end of the first flow passage;
a second sub-flow passage having the second end of the first flow passage, wherein the second sub-flow passage is connected to the third end of the second flow passage.

5. The cooling module according to claim 4, further comprising:
a plurality of first flow passage assemblies, wherein the fourth end of the second flow passage of each first flow passage assembly is connected to the first end of the first sub-flow passage of the adjacent first flow passage assembly.

6. The cooling module according to claim 4, further comprising:
a plurality of third flow passages, wherein each third flow passage connects the fourth end of the second flow passage of the adjacent first flow passage assembly and the first end of the first sub-flow passage of the adjacent first flow passage assembly.

7. The cooling module according to claim 2, further comprising:
a first opening located at the one of the first flow passage assemblies that is located at one end of the first flow passage assemblies; and
a second opening located at the one of the first flow passage assemblies that is located at the other end of the first flow passage assemblies.

8. The cooling module according to claim 2, further comprising:
a plurality of second flow passage assemblies separated from the first flow passage assemblies.

9. The cooling module according to claim 8, further comprising:
a first opening located at the one of the first flow passage assemblies that is located at one end of the first flow passage assemblies;
a second opening located at the one of the first flow passage assemblies that is located at the other end of the first flow passage assemblies;
a third opening located at the one of the second flow passage assemblies that is located at one end of the second flow passage assemblies; and
a fourth opening located at the one of the second flow passage assemblies that is located at the other end of the second flow passage assemblies.

10. The cooling module according to claim 1, wherein the main body comprises a divider, the main body has a first inner lateral wall and a second inner lateral wall opposite to the first inner lateral wall, the divider is disposed on one of the first inner lateral wall and the second inner lateral wall for changing the flowing direction of the cooling fluid flowing through the first flow passage assembly.

11. A water-cooled motor system comprising:
a cooling module comprising:
a main body comprising a first lateral portion and a second lateral portion opposite to the first lateral portion;
a first flow passage assembly disposed in the main body, wherein the first flow passage assembly comprises:
a first flow passage having a first end and a second end, wherein the first end is adjacent to one of the first lateral portion and the second lateral portion, and the second end is adjacent to the other one of the first lateral portion and the second lateral portion; and
a second flow passage having a third end and a fourth end, wherein the third end is connected to the second end of the first flow passage, and the fourth end is adjacent to one of the first lateral portion and the second lateral portion; and
a motor assembly disposed in the main body for delivering a traction power.

12. The water-cooled motor system according to claim 11, wherein the cooling module further comprises:
a plurality of first flow passage assemblies, wherein the fourth end of the second flow passage of each first flow passage assembly is connected to the first end of the first flow passage of the adjacent first flow passage assembly.

13. The water-cooled motor system according to claim 12, wherein the cooling module further comprises:
a plurality of third flow passages, wherein each third flow passage connects the fourth end of the second flow passage of the adjacent first flow passage assembly and the first end of the first flow passage of the adjacent first flow passage assembly.

14. The water-cooled motor system according to claim 11, wherein the first flow passage comprises:
a first sub-flow passage having the first end of the first flow passage;
a second sub-flow passage having the second end of the first flow passage, wherein the second sub-flow passage is connected to the third end of the second flow passage.

15. The water-cooled motor system according to claim 14, further comprising:
a plurality of first flow passage assemblies, wherein the fourth end of the second flow passage of each first flow passage assembly is connected to the first end of the first sub-flow passage of the adjacent first flow passage assembly.

16. The water-cooled motor system according to claim 14, wherein the cooling module further comprises:
a plurality of third flow passages, wherein each third flow passage connects the fourth end of the second flow passage of the adjacent first flow passage assembly and the first end of the first sub-flow passage of the adjacent first flow passage assembly.

17. The water-cooled motor system according to claim 12, wherein the cooling module further comprises:
a first opening connected to the one of the first flow passage assemblies that is located at one end of the first flow passage assemblies; and
a second opening connected to the one of the first flow passage assemblies that is located at the other end of the first flow passage assemblies.

18. The water-cooled motor system according to claim 12, wherein the cooling module further comprises:
a plurality of second flow passage assemblies separated from the first flow passage assemblies.

19. The water-cooled motor system according to claim 18, wherein the cooling module further comprises:
a first opening connected to the one of the first flow passage assemblies that is located at one end of the first flow passage assemblies;
a second opening connected to the one of the first flow passage assemblies that is located at the other end of the first flow passage assemblies;
a third opening connected to the one of the second flow passage assemblies that is located at one end of the second flow passage assemblies; and
a fourth opening connected to the one of the second flow passage assemblies that is located at the other end of the second flow passage assemblies.

20. The water-cooled motor system according to claim 11, wherein the main body comprises a divider, the main body has a first inner lateral wall and a second inner lateral wall opposite to the first inner lateral wall, the divider is disposed on one of the first inner lateral wall and the second inner lateral wall for changing the flowing direction of the cooling fluid flowing through the first flow passage assemblies.
